(19) United States
(12) Patent Application Publication
(10) Pub. No.: US 2012/0237795 A1
(43) Pub. Date: Sep. 20, 2012

(54) MAGNETIC RECORDING MEDIUM AND METHOD FOR MANUFACTURING THE SAME

(75) Inventors: MASATOSHI SAKURAI, Tokyo (JP); KAORI KIMURA, Yokohama-shi (JP); HIROYUKI HYODO, Hino-shi (JP); TAKESHI IWASAKI, Inagi-shi (JP)

(73) Assignee: KABUSHIKI KAISHA TOSHIBA, Tokyo (JP)

(21) Appl. No.: 13/295,563

(22) Filed: Nov. 14, 2011

(30) Foreign Application Priority Data
Mar. 15, 2011 (JP) 2011-057115

(51) Int. Cl. G11B 5/66; G11B 5/84

(52) U.S. Cl. 428/800; 216/22

(57) ABSTRACT

According to one embodiment, a magnetic recording medium includes a substrate, a magnetic recording layer formed on the substrate and containing a magnetic material, and a protective layer. The magnetic recording layer includes a recording portion having patterns regularly arranged in the longitudinal direction, and a non-recording portion having saturation magnetization lower than that in the recording portion. The non-recording portion contains the magnetic material, a deactivating species which makes the value of saturation magnetization smaller than that of saturation magnetization in the recording portion, and the component of the protective layer.

### CROSS-REFERENCE TO RELATED APPLICATIONS

This application is based upon and claims the benefit of priority from prior Japanese Patent Application No. 2011-057115, filed Mar. 15, 2011, the entire contents of which are incorporated herein by reference.

### FIELD

Embodiments described herein relate generally to a magnetic recording medium and a method for manufacturing the same.

### BACKGROUND

In a conventional structure of a patterned medium, magnetic/non-magnetic patterning (deactivation) has been executed in a manner of mixing other elements with a non-recording portion of the patterned medium and worsening crystallization or reducing Tc by a dilution effect. However, it is known that mere mixture of the elements of deactivating species with the non-recording portion causes the elements mixed with the non-recording portion to alloy with previously existing elements and the adhesion to a protective layer to be degraded. In addition, at implantation of the elements of deactivating species executed by ion implantation, etc., the implanted elements may cause volume expansion if they are bulky as compared with light elements such as B, C, N, etc. Thus, a problem arises that the thickness of the protective layer must be decreased at a non-recording region alone to planarize a surface of a magnetic recording medium.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a sectional view showing an example of the structure of a magnetic recording medium according to an embodiment;

FIG. 2 is a graph showing an example of the element concentration distribution in the depth direction of a recording portion of the magnetic recording medium according to the embodiment;

FIG. 3 is a graph showing an example of the element concentration distribution in the depth direction of a non-recording portion of the magnetic recording medium according to the embodiment;

FIG. 4 is a plan view in the circumferential direction of a bit-patterned medium as an example of a patterned medium according to the embodiment;

FIG. 5 is a plan view taken along the circumferential direction of a DTR medium according to the embodiment;

FIG. 6 is a perspective view showing a magnetic recording apparatus incorporating the magnetic recording medium according to the embodiment;

FIGS. 7A, 7B, 7C, 7D, 7E, 7F, 7G, and 7H are exemplary views for explaining an example of a method for manufacturing the magnetic recording medium according to the embodiment;

FIGS. 8A, 8B, 8C, 8D, 8E, 8F, 8G, 8H, and 8I are exemplary views for explaining another example of the method for manufacturing the magnetic recording medium according to the embodiment; and

FIGS. 9A, 9B, 9C, 9D, 9E, 9F, 9G, 9H, 9I, and 9J are exemplary views for explaining still another example of a method for manufacturing the magnetic recording medium according to the embodiment.

### DETAILED DESCRIPTION

Various embodiments will be described hereinafter with reference to the accompanying drawings.

In general, according to one embodiment, a magnetic recording medium includes a substrate, a magnetic recording layer formed on the substrate and containing a magnetic material, and a protective layer. The magnetic recording layer includes a recording portion having patterns regularly arranged in the longitudinal direction, and a non-recording portion having saturation magnetization lower than that of the recording portion. The non-recording portion contains a magnetic material, a deactivating species that makes the value of saturation magnetization smaller than that of the recording portion, and the component of the protective layer.

Note that the magnetic material herein mentioned is a material having magnetic properties, and examples are elements such as Co, Fe, and Ni, magnetic rare-earth elements such as Nd, Pm, Sm, Eu, Dy, and Ho, and alloys containing these elements. The magnetic material also includes an alloy and superlattice not having magnetism alone but having ordered phases of Cr and Pt.

A method of manufacturing the magnetic recording medium according to the embodiment includes a step of forming, on the upper surface of the protective layer of the magnetic recording medium, a mask layer including projections having regularly arranged patterns, and a step of forming, in the magnetic recording layer, a recording portion having regularly arranged patterns, and a non-recording portion having saturation magnetization lower than that of the recording portion. The non-recording portion is formed by performing, through the mask layer including the projections having the regularly arranged patterns, ion beam irradiation of a magnetic material and a deactivating species that makes the value of saturation magnetization smaller than that of the recording portion, thereby deactivating the magnetic recording layer in recesses between the projections in the thickness direction. The obtained non-magnetic portion contains the deactivating species and the component of the protective layer, in addition to the magnetic material. The magnetic recording medium to be used includes a substrate, a magnetic recording layer formed on the substrate, and a protective layer formed on the magnetic recording layer.

This embodiment can improve the adhesion to the protective layer by mixing not only the deactivating species that deactivates magnetism but also the protective layer component in the non-recording portion. Therefore, even when the non-recording portion causes volume expansion and decreases the thickness of the projective layer on the non-recording portion, the protective layer hardly peels from the non-recording portion and does not degrade the effect as the protective layer. This makes it possible to stably perform high-quality recording and reproduction.

The embodiment will be explained below with reference to the accompanying drawing.

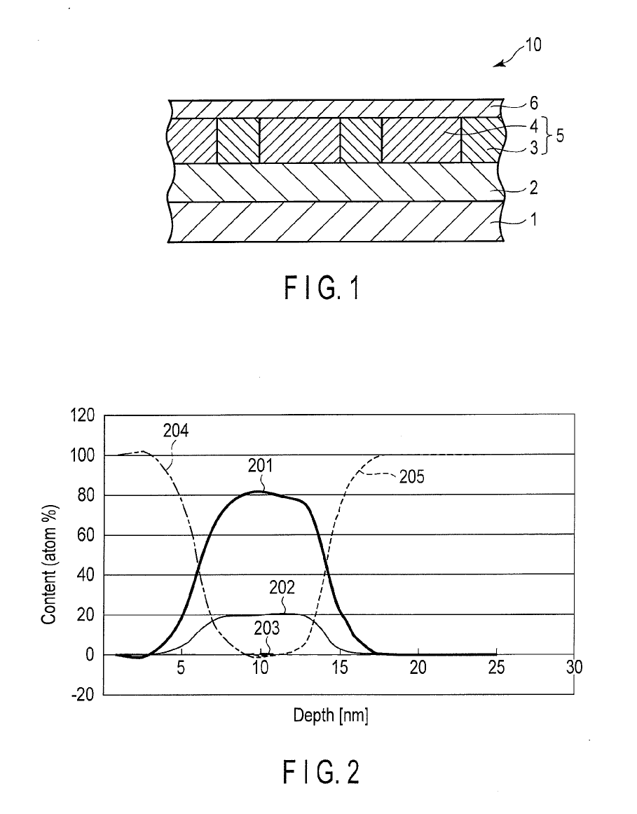

FIG. 1 is a sectional view showing an example of the structure of the magnetic recording medium according to the embodiment.

A magnetic recording medium 10 has a structure in which an underlayer 2 (including an adhesion layer, soft magnetic layer, and orientation control interlayer), magnetic recording layer 5, and protective layer 6 are stacked on a substrate 1. The magnetic recording layer 5 is divided into a recording portion 3 and non-recording portion 4. The recording portion 3 consists of a perpendicularly oriented ferromagnetic material. The non-recording portion 4 consists of a material having a saturation magnetization Ms smaller than that of the recording portion 3.

From the viewpoint of composition stability, the non-recording portion 4 can contain, as a principal constituent element, the same component as that of the recording portion 3. If the compositions of the constituent elements of the recording portion 3 and non-recording portion 4 are biased, the diffusion of the magnetic element in the recording portion 3 may pose a problem.

The non-recording portion contains at least one deactivating species selected from the group consisting of, for example, P, As, Sb, and Bi, and reduces or eliminates the magnetism of the magnetic element contained in the recording portion. The higher the composition ratio of the element functioning as the deactivating species, the higher the deactivation effect. However, if the compositions of the constituent elements of the recording portion and non-recording portion are biased, the diffusion of the magnetic element in the recording portion poses a problem. Accordingly, the content of the element functioning as the deactivating species can be 1 to 90 at %, and can also be 5 to 50 at %, relative to the magnetic element. Similar to the element of the deactivating species, the non-recording portion can contain the element having the same composition as that of the protective layer.

Furthermore, in the magnetic recording medium 10 as shown in FIG. 1, the protective layer 6 is formed in contact with the magnetic recording layer 5, and a distance h2 from the substrate 2 to the interface between the non-recording portion 4 and protective layer 6 is greater than a distance h1 from the substrate 2 to the interface between the recording portion 3 and protective layer 6. Since h2 is greater than h1, the area of the interface with the protective layer increases. This effectively increases the adhesion between the protective film and medium.

FIG. 2 shows an example of the element concentration distribution in the depth direction of the recording portion of the magnetic recording medium according to the embodiment.

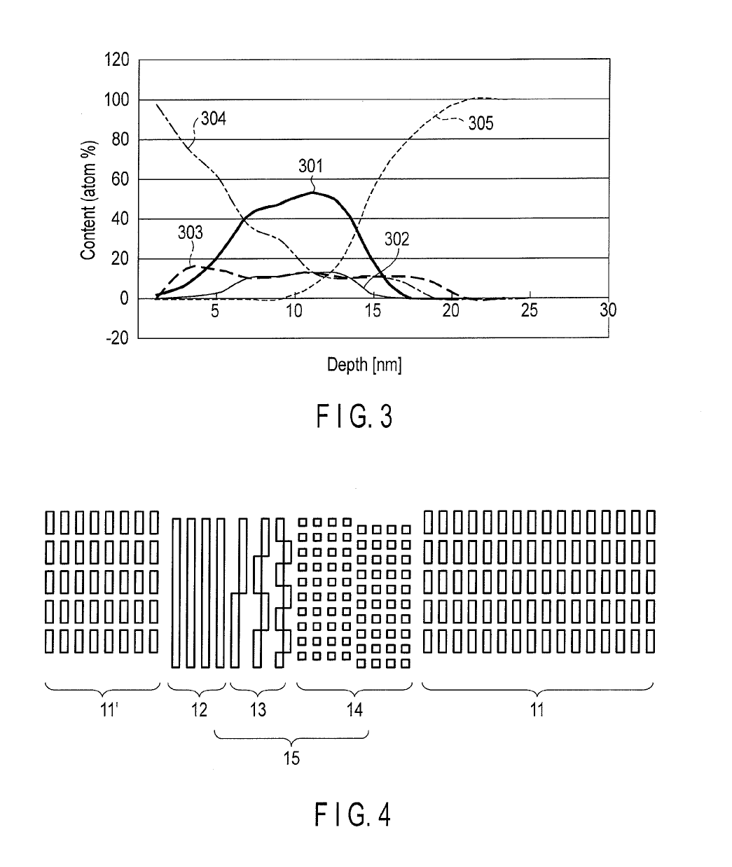

FIG. 3 shows an example of the element concentration distribution in the depth direction of the non-recording portion of the magnetic recording medium according to the embodiment.

In FIG. 2, reference number 201 denotes the Co content; 202, the Pt content; 203, the P content; 204, the C content; and 205, the Ru content.

In FIG. 3, reference number 301 denotes the Co content; 302, the Pt content; 303, the P content; 304, the C content; and 305, the Ru content.

In the magnetic recording medium having properties shown in FIG. 2 and FIG. 3, the protective layer is C, the recording layer is CoPt, and the element of the deactivating species is P. The concentration distributions were measured by X-ray photoelectron spectroscopy (XPS). The measurement results were processed such that the unit of the ordinate is atom %. The C protective layer, the CoPt layer (Co:Pt=8:2), and the Ru orientation control interlayer were detected in this order from the surface of the recording portion shown in FIG. 2. A portion closer to the substrate than Ru is omitted. The C protective layer was detected on the surface of the non-recording portion shown in FIG. 3, and the CoPt layer containing P and C and the Ru orientation control interlayer were detected below the C protective layer. The composition ratio of the protective layer component in the magnetic recording layer changed in the thickness direction: the composition ratio of the protective layer component on the protective layer side was higher than that of the protective layer component on the substrate side. Also, the composition ratio of the orientation control interlayer component in the non-recording portion was higher than that of the orientation control interlayer component in the recording portion.

The depth profile of XPS is measured by repetitively etching the sample surface with an Ar ion beam and subsequently performing XPS measurement. Therefore, an unsharpened material interface may be measured because of knocking of the surface element. Referring to FIG. 2, C was observed to a depth of about 8 nm from the actual outermost surface. When performing measurement by sectional TEM or the like, however, the film was actually deposited to a thickness of 5 nm, and the interface with CoPt was steep. As an example in a case like this, the cross point between C and Co in XPS intensity can be regarded as the interface between C and CoPt. Also, in an arrangement including a substrate/CoPt/Co/C protective film, the boundary between CoPt and Co cannot be known from the cross point. In this case, the boundary is determined in accordance with the reduction in Pt concentration (e.g., it is possible to freely select the point of 1/2 concentration).

FIG. 4 is a plan view in the circumferential direction of a bit-patterned medium as an example of a patterned medium according to the embodiment.

Servo areas 15 and data areas 11 are alternately formed along the circumferential direction of the patterned medium. The servo area 15 includes a preamble portion 12, address portion 13, and burst portion 14. In the data area 11, a data track region in which adjacent dots are separated is formed.

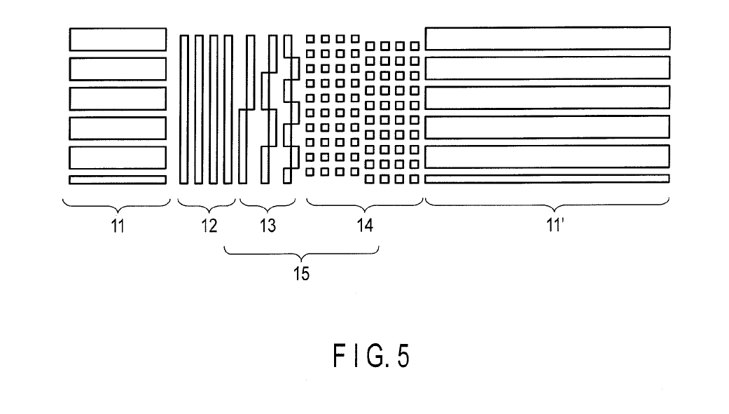

FIG. 5 is a plan view taken along the circumferential direction of a discrete track medium (DTR medium) as another example of the patterned medium according to the embodiment.

This DTR medium has the same arrangement as that shown in FIG. 4, except that discrete tracks obtained by separating adjacent tracks are formed in a data area 11′.

The material of the protective layer to be used in the embodiment can contain carbon as a main component. For example, it is possible to use diamond-like carbon (DLC), CNₓ (x=0.05 to 0.33) to which N is added, or CH_{y} (y=0.2 to 0.7) to which H is added. If the content of N or H as an additive is too large, the intensity decreases or the surface properties worsen.

Distributing the material having the same component as that of the protective layer in the non-recording portion effectively increases the adhesion between the non-recording portion and protective layer. The component of the protective layer can be 1 at % or more, and can also be 5 at % or more, in a 2-nm-thick region from the outermost surface of the non-recording portion. The outermost surface of the non-recording portion herein mentioned is a position where the element contained in the recording layer is detected at 50 at % or more of the saturation concentration when the composition is measured in the direction from the surfacemost protective layer to the substrate of the medium by XPS or the like.

Also, the concentration of the protective layer component on the orientation control interlayer side can be lower than that of the protective layer component on the surface side. If the concentration is high on the orientation control interlayer side, the component of the protective layer diffuses through the grain boundary in the interlayer to cause the deterioration of the magnetic characteristic of the recording portion.

As a method of adding the protective layer component to the non-recording portion, the element of the protective layer can be implanted by ion implantation at the same time, before, or after the element of the deactivating species is ion-implanted. Alternatively, it is also possible to leave the protective layer behind on the recording layer beforehand, and mix the protective layer element in the non-recording portion by mixing during ion implantation. Furthermore, the protective layer element can be added when filling projections and recesses formed in the recording layer, and can also be implanted by ion implantation after the projections and recesses are filled.

When magnetism is deactivated by ion implantation, the volume of the non-recording portion sometimes expands. This sometimes produces a difference between the protective layer thicknesses in the non-recording portion and recording portion. Since the component of the protective layer is mixed in the non-recording portion, however, the effect as the protective layer does not worsen even when the film thickness of the protective layer decreases. In addition, when the heights of the non-recording portion and recording portion are different, the area of the interface between the protective layer and recording layer increases, so the adhesion of the protective layer further increases.

The deactivation of magnetism herein mentioned is to increase the concentration of the element of the deactivating species in the non-recording portion with respect to that in the recording portion, thereby reducing the saturation magnetization Ms. Materials suitable for magnetism deactivation are P, As, Sb, and Bi. This is so because P, As, Sb, or Bi as a group-15 element forms a semi-metallic bond having strong covalent with a magnetic element such as Co, Ni, or Fe, thereby changing the spin structure. Magnetism can efficiently be reduced by means of any of these materials. The deactivation effect increases as the composition ratio of the element of the deactivating species increases, but the above-described diffusion problem arises if the composition ratio is too high. The composition ratio of the element of the deactivating species can be 1 to 90 at % with respect to the magnetic element. The composition ratio of the element of the deactivating species can also be 3 to 50 at % with respect to the magnetic element.

Ion beam irradiation such as an ion implantation method can be used in magnetic-nonmagnetic patterning. It is possible to efficiently implant the element of the deactivating species in only the non-recording portion by masking the recording portion. When performing ion beam irradiation, a large amount of the element of the deactivating species desirably distributes in a region between the interlayer and outermost surface. It is also possible to completely remove the non-recording portion, and bury the material after that. Furthermore, it is possible to bury a material obtained by adding the element of the deactivating species and the protective layer material to the material having the same composition as that of the original recording portion.

When patterning is performed by ion implantation or the like, the volume sometimes changes. For example, when the film thickness of the recording layer is 10 nm, a change of 10% is equivalent to 1 nm. The volume change ratio derived from that can be 40% or less. The volume change ratio can also be 20%, and can further be 10% or less.

When the magnetic recording layer to be used in the embodiment is an alloy, the layer contains Co, Fe, or Ni as a main component, and can contain Pt or Pd. The magnetic recording layer can also contain Cr or an oxide as needed. Silicon oxide and titanium oxide are particularly favorable oxides. In addition to the oxide, the magnetic recording layer can further contain one or more elements selected from Ru, Mn, B, Ta, Cu, and Pd. These elements can improve the crystallinity and orientation. This makes it possible to obtain recording/reproduction characteristics and thermal decay characteristics suited to high-density recording.

As the perpendicular magnetic recording layer, it is also possible to use, for example, any of a CoPt-based alloy, an FePt-based alloy, a CoCrPt-based alloy, an FePtCr-based alloy, CoPtO, FePtO, CoPtCrO, FePtCrO, CoPtSi, and FePtSi, or a multilayered structure containing Co, Fe, or Ni and an alloy mainly containing at least one element selected from the group consisting of Pt, Pd, Ag, and Cu. Furthermore, it is also possible to use an MnAl alloy, SmCo alloy, FeNbB alloy, or CrPt alloy having a high Ku.

The thickness of the perpendicular magnetic recording layer can be, for example, 3 to 30 nm, and can also be 5 to 15 nm. When the thickness falls within this range, a magnetic recording/reproduction apparatus suited to a high recording density can be manufactured. If the thickness of the perpendicular magnetic recording layer is less than 3 nm, the reproduction output becomes too low, so the noise component becomes higher than the reproduction output. If the thickness of the perpendicular magnetic recording layer exceeds 30 nm, the reproduction output becomes too high and distorts the waveform.

An orientation control interlayer of a nonmagnetic material can be formed between the soft magnetic backing layer and magnetic recording layer. The orientation control interlayer has two functions, i.e., interrupts the exchanging coupling interaction between the soft magnetic backing layer and magnetic recording layer, and controls the crystallinity of the magnetic recording layer. As the material of the orientation control interlayer, it is possible to use Ru, Pt, Pd, W, Ti, Ta, Cr, Si, Ni, Mg, an alloy containing any of these elements, or an oxide or nitride of any of these elements.

The soft magnetic backing layer (SUL) to be used in the embodiment horizontally passes a recording magnetic field from a single-pole head for magnetizing the perpendicular magnetic recording layer, and returns the magnetic field toward the magnetic head, i.e., performs a part of the function of the magnetic head. The soft magnetic backing layer has a function of applying a sufficient steep perpendicular magnetic field to the recording layer, thereby increasing the recording/reproduction efficiency. A material containing Fe, Ni, or Co can be used as the soft magnetic backing layer. Examples of the material are FeCo-based alloys such as FeCo and FeCoV, FeNi-based alloys such as FeNi, FeNiMo, FeNiCr, and FeNiSi, FeAl- and FeSi-based alloys such as FeAl, FeAlSi, FeAlSiCr, FeAlSiTiRu, and FeAlO, FeTa-based alloys such as FeTa, FeTaC, and FeTaN, and FeZr-based alloys such as FeZrN. It is also possible to use a material having a microcrystalline structure or a granular structure in which fine crystal grains are dispersed in a matrix. Examples are FeAlO, FeMgO, FeTaN, and FeZrN containing 60 at % or more of Fe. As another material of the soft magnetic backing layer, it is also possible to use a Co alloy containing Co and at least one of Zr, Hf, Nb, Ta, Ti, and Y. The Co alloy can contain 80 at % or more of Co. When this Co alloy is deposited by sputtering, an amorphous layer readily forms. The amorphous soft magnetic material has none of magnetocrystalline anisotropy, a crystal defect, and a grain boundary, and hence has very high soft magnetism and can reduce the noise of the medium. Examples of the amorphous soft magnetic material are CoZr-, CoZrNb-, and CoZrTa-based alloys.

An underlayer can further be formed below the soft magnetic backing layer in order to improve the crystallinity of the soft magnetic backing layer or improve the adhesion to the substrate. As the material of this underlayer, it is possible to use Ti, Ta, W, Cr, Pt, an alloy containing any of these elements, or an oxide or nitride of any of these elements.

In order to prevent spike noise, it is possible to divide the soft magnetic backing layer into a plurality of layers, and insert a 0.5- to 1.5-nm-thick Ru layer, thereby causing antiferromagnetic coupling. The soft magnetic backing layer can also be exchange-coupled with a hard magnetic layer having longitudinal anisotropy such as CoCrPt, SmCo, or FePt, or an antiferromagnetic layer such as IrMn or PtMn. To control the exchange coupling force, it is possible to stack magnetic films (e.g., Co) or nonmagnetic films (e.g., Pt) on the upper and lower surfaces of the Ru layer.

As the mask layer to be used in the embodiment, a first hard mask (release layer), second hard mask, and third hard mask, for example, are deposited in this order on the surface layer of the magnetic recording layer of the magnetic recording medium for a patterned medium.

As the first hard mask, a 1- to 10-nm-thick film of Mo, Mg, Al, Sc, Ti, V, Mn, Y, Zr, Nb, La, Ce, Nd, Sm, Eu, Gd, Hf, Al, Zn, Sn, Pb, Ga, In, or an alloy of any of these elements is deposited. As the second hard mask, a 4- to 50-nm-thick film of a material containing more than 75 at % of carbon is deposited. As the third hard mask, a 1- to 10-nm-thick film of Si, Ti, Ta, Mo, W, or an oxide or nitride of any of these elements is deposited.

Note that a 1- to 5-nm-thick carbon protective layer is deposited as a protective layer between the first hard mask and magnetic recording layer.

In an imprinting step of a stamper for use in the embodiment, the surface of the magnetic recording layer of the magnetic recording medium for a patterned medium is first evenly coated with a resist by, for example, spin coating, dipping, or an ink-jet method. A general photosensitive resin, thermoplastic resin, or thermosetting resin can be used as the resist. As the resin, it is possible to use a resin that can be etched by RIE using a gas containing oxygen or fluorine.

As the imprinting stamper, it is possible to use a stamper made of a material such as quartz, a resin, Si, or Ni. When using a stamper made of quartz or a resin, imprinting can be performed by using as the resist a photosensitive resin (photoresist) that is cured by ultraviolet light. When the resist is a thermosetting or thermoplastic resin, a stamper made of, for example, Si or Ni can be used because heat or pressure is applied during imprinting.

For example, when a resin stamper having recording tracks and servo information patterns is pressed with 5 t for 60 s and irradiated with ultraviolet light for 10 s, the patterns can be transferred onto the resist. Pressing can be performed by stacking the stamper, substrate, and stamper on the lower plate of a die set, and sandwiching the stack between the upper and lower plates of the die set. The two surfaces of the substrate are coated with a resist in advance. The stamper and substrate are set such that a three-dimensional surface of the stamper faces the resist film side of the substrate. Since the height of the three-dimensional structure of the patterns formed by imprinting is 30 to 50 nm, the residue is about 5 to 20 nm. When the stamper is coated with a fluorine-based release material, the stamper can easily be released from the resist.

The resist residue after imprinting can be removed by reactive ion etching (RIE). A plasma source is preferably a inductively coupled plasma (ICP) by which a high-density plasma can be generated at low pressure. However, it is also possible to use an electron cyclotron resonance (ECR) plasma or a general parallel-plate RIE apparatus. When using a photosensitive resin as the resist, gaseous O₂, gaseous CF₄, or a gaseous mixture of O₂ and CF₄ can be used. It is also possible to use a gas obtained by adding H₂ to any of the above-mentioned gases, and to use CHF₃, Cl₂, or HBr instead of CF₄. When using an Si-based material (e.g., spin-on-glass [SOG]) as the resist, fluorine-gas RIE using, for example, CF₄ or SF₆ can be employed. The removal of the resist is terminated when the third hard mask below the resist is exposed.

After imprinting and the removal of the resist residue, the third hard mask is patterned by using the patterned resist as a mask. The third hard mask can be patterned by means of RIE or another type of ion beam etching. A halogen-based gas such as CF₄ or SF₆ is used in patterning. A slight amount of H₂ can be added to a process gas in order to protect the resist, and CHF₃, Cl₂, or HBr can be used instead of CF₄. When a rare gas such as Ar is added as an assistant, the selectivity to the resist can be increased. The patterning of the third hard mask is terminated when the surface of the second hard mask is exposed.

After the third hard mask is patterned, the second hard mask is patterned. The second hard mask can be patterned by means of either RIE or ion beam etching. Examples of an etching gas are O₂, O₃, N₂, H₂, and mixtures of these gases. The patterning of the second hard mask is terminated when the surface of the first hard mask is exposed.

After the second hard mask is patterned, the first hard mask is patterned as needed. The first hard mask need not be patterned if the magnetic recording layer is patterned by ion implantation while the first hard mask is left behind.

When patterning the first hard mask, it is possible to perform RIE using a reactive gas or ion beam etching using a rare gas, as in the patterning of the third hard mask. The patterning of the second hard mask is terminated when the surface of the protective layer on the magnetic recording layer is exposed.

After the first hard mask is patterned, the magnetic recording layer is patterned. The patterning of the magnetic recording layer herein mentioned is to magnetically isolate the magnetic material. The magnetic recording layer is patterned by means of a method of separating a non-recording portion by deactivating it with ion beam irradiation. The deactivation step means a step of weakening the magnetism of the ferromagnetic recording layer in recesses compared to that on projections in the patterned magnetic recording medium. Weakening the magnetism decreases MsT (the product of saturation magnetization and film thickness), and includes ferrimagnetization, paramagnetization, and ferromagnetization. A change in magnetism like this can be observed by measuring the value of, for example, Ms, Hn, Hs, or He by means of a vibrating sample magnetometer (VSM) or Kerr (magneto-optical Kerr effect) measuring instrument.

The magnetism deactivation step is performed by implanting P, As, Sb, or Bi into the non-recording portion by ion beam irradiation. As an ion beam source, it is possible to use gaseous PH₃, AsH₃, or SbH₃, or a plasma obtained by vaporizing each element or a compound of each element.

When adding the protective layer element together with the deactivating species by ion implantation, an ion source such as gaseous CH₄, CN, or CO₂ is used.

When adding the protective layer component by mixing, it is necessary to make mixing easy to occur by implantation. The implantation energy can be adjusted so as to irradiate the surface with a sufficient amount of ions. If the implantation film thickness is 15 nm or less, however, the surface is irradiated with sufficient ions, so energy control may be unnecessary.

After the magnetic recording layer is patterned, the first hard mask is removed. The removal of the first hard mask is to expose the surface of the protective layer below the first hard mask. The second hard mask, third hard mask, and the like remaining on the first hard mask are removed together with the first hard mask. The first hard mask can be removed by a wet process using, for example, water, weak acid, or weak alkali as a remover. This removing method can remove the mask without damaging the magnetic recording layer. When Mo is used as the first hard mask, for example, the mask can be removed by dipping the magnetic recording medium in a 0.1-wt % hydrogen peroxide solution for 10 min.

After the removal, the magnetic recording medium is washed with water or a solvent so that no removal remains.

The carbon protective layer can be deposited by CVD in order to improve the coverage for the projections and recesses. Alternatively, the protective layer can be deposited by sputtering or vacuum deposition. CVD forms a DLC film containing a large amount of sp³-bonded carbon. The film thickness of the carbon protective layer can be 2 to 10 nm. If the film thickness is less than 2 nm, the coverage worsens. If the film thickness exceeds 10 nm, the magnetic spacing between a recording/reproduction head and the medium increases, and the SNR decreases. The protective layer can be coated with a lubricant. As the lubricant, it is possible to use, for example, perfluoropolyether, alcohol fluoride, or fluorinated carboxylic acid.

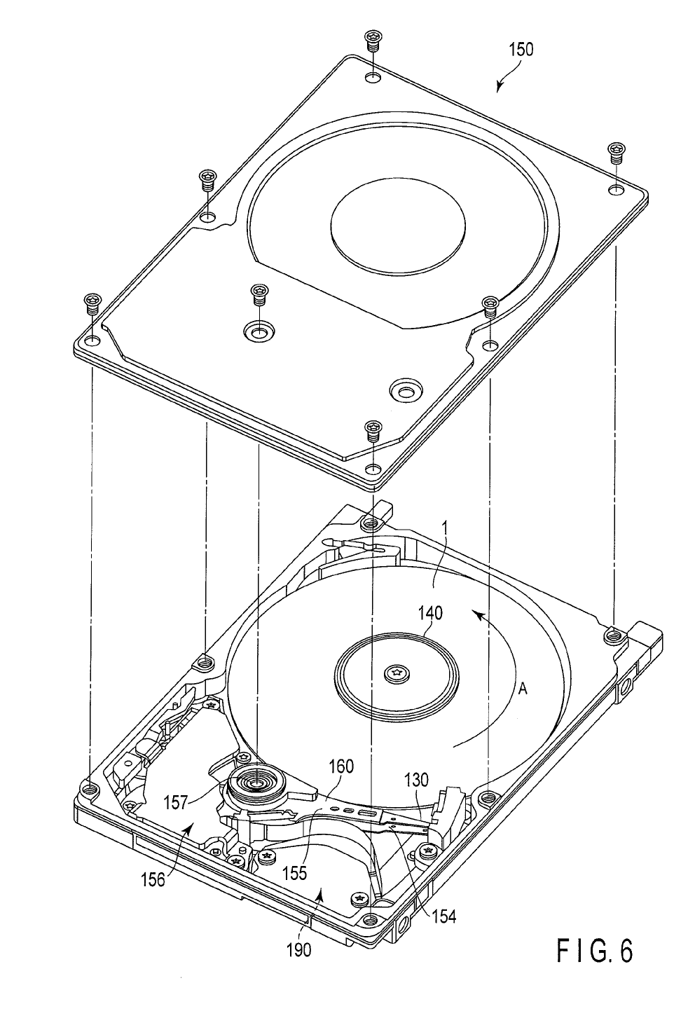

FIG. 6 is a perspective view showing a magnetic recording apparatus incorporating the magnetic recording medium according to the embodiment.

As shown in FIG. 6, a magnetic recording apparatus 150 according to the embodiment is an apparatus using a rotary actuator. A patterned medium 1 is attached to a spindle motor 140, and rotated in the direction of an arrow A by a motor (not shown) in response to a control signal from a driver controller (not shown). The magnetic recording apparatus 150 may also include a plurality of patterned media 1.

A head slider 130 for performing information recording and reproduction on the patterned medium 1 is attached to the distal end of a thin-film suspension 154. A magnetic head is installed near the distal end of the head slider 130. When the patterned medium 1 rotates, the pressing force of the suspension 154 balances with a pressure generated on that surface (ABS) of the head slider 130, which faces the medium. That surface of the head slider 130, which is opposite to the medium is held with a predetermined floating amount from the surface of the patterned medium 1.

The suspension 154 is connected to one end of an actuator arm 155 including a bobbin for holding a driving coil (not shown). A voice coil motor 156 as a kind of a linear motor is formed at the other end of the actuator arm 155. The voice coil motor 156 can be formed by the driving coil (not shown) wound on the bobbin of the actuator arm 155, and a magnetic circuit including a permanent magnet and counter yoke arranged to face each other so as to sandwich the coil. The actuator arm 155 is held by ball bearings (not shown) formed in two portions above and below a pivot 157, and freely pivoted by the voice coil motor 156. Consequently, the magnetic head can access a given position of the patterned medium 1.

### EXAMPLES

The embodiment will be explained in more detail below by way of its examples.

### Example 1

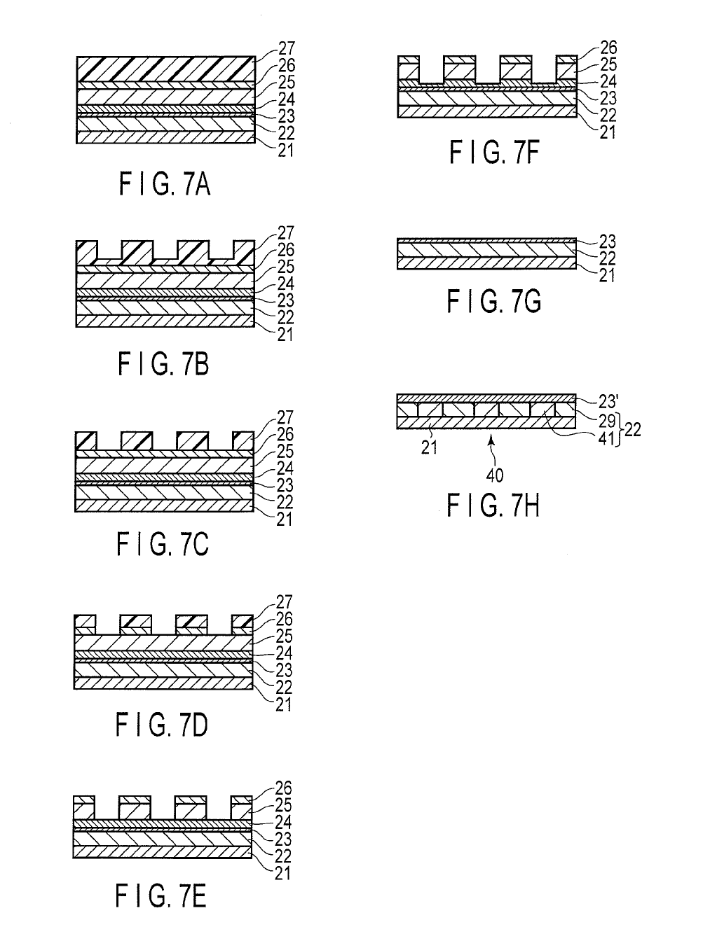

FIGS. 7A, 7B, 7C, 7D, 7E, 7F, 7G, and 7H are exemplary views for explaining an example of a method of manufacturing the magnetic recording medium according to the embodiment.

As shown in FIG. 7A, a 40-nm-thick soft magnetic layer (CoZrNb) (not shown), a 20-nm-thick orientation control interlayer (Ru) (not shown), a 10-nm-thick magnetic recording layer 22 (Co₈₀Pt₂₀), a 2-nm-thick DLC protective layer 23, a 5-nm-thick first hard mask (Mo) 24, a 30-nm-thick second hard mask (C) 25, and a 3-nm-thick third hard mask (Si) 26 are deposited on a glass substrate 21. A resist 27 is formed on the third hard mask 26 by spin coating so as to have a thickness of 80 nm. A general photoresist is an example of the resist. Meanwhile, a stamper (not shown) having predetermined three-dimensional patterns corresponding to the patterns shown in FIG. 4 or 5 is prepared. This stamper is manufactured through EB lithography, Ni electroforming, and injection molding. The stamper is set such that its three-dimensional surface is opposite to the resist 27.

As shown in FIG. 7B, the stamper is imprinted on the resist 27, thereby transferring the three-dimensional patterns of the stamper onto the resist 27. After that, the stamper is removed. The resist residue remains on the bottoms of recesses of the three-dimensional patterns transferred onto the resist 27.

As shown in FIG. 7C, the resist residue in the recesses is removed by dry etching, thereby exposing the surface of the third hard mask 26. For example, this step is performed for an etching time of 60 s with an inductively coupled plasma (ICP) RIE apparatus using CF₄ as a process gas at a chamber pressure of 0.1 Pa, a coil RF power of 100 W, and a platen RF power of 50 W.

As shown in FIG. 7D, the patterns are transferred onto the third hard mask 26 by ion beam etching by using the patterned resist 27 as a mask, thereby exposing the second hard mask 25 in the recesses. For example, this step is performed for an etching time of 20 s with the inductively coupled plasma (ICP) RIE apparatus using CF₄/H₂ as a process gas at a chamber pressure of 0.1 Pa, a coil RF power of 100 W, and a platen RF power of 30 W.

As shown in FIG. 7E, the patterns are transferred by etching the second hard mask 25 made of C by using the patterned third hard mask 26 as a mask, thereby exposing the surface of the first hard mask 24 in the recesses. For example, this step is performed for an etching time of 30 s with the inductively coupled plasma (ICP) RIE apparatus using O₂ as a process gas at a chamber pressure of 0.1 Pa, a coil RF power of 100 W, and a platen RF power of 50 W.

As shown in FIG. 7F, the magnetism of a non-recording portion is deactivated through the first hard mask 24 made of Mo. For example, this step is performed for a processing time of 60 s by sequentially emitting P⁺ ions at acceleration energies of 5, 7.5, and 10 keV by ion implantation at a dose of ˜10¹⁶ atoms/cm². In this step, the DLC protective layer closer to the substrate than Mo causes mixing with CoPt.

As shown in FIG. 7G, the remaining first hard mask (Mo) 24 is removed together with its upper layers. In this step, the medium is dipped in, for example, a hydrogen peroxide solution having a concentration of 0.1% and held for 30 min, thereby removing the remaining second hard mask 25 and all the films deposited on it.

As shown in FIG. 7H, a protective layer 23′ is formed by depositing DLC by chemical vapor deposition (CVD), and coated with a lubricant, thereby obtaining a patterned medium 40 according to the embodiment in which a magnetic recording layer 22 including a recording portion 29 and non-recording portion 41, the protective layer 23′, and the lubricating layer are formed on the substrate 21.

The manufactured patterned medium was incorporated into a drive, and servo positioning evaluation was performed.

Servo positioning evaluation was performed by measuring the position variation when tracking was performed. Evaluation was good when 3σ of the position variation was 10% or less of the track pitch, satisfactory when 3σ of the position variation was 30% or less of the track pitch, and bad when 3σ of the position variation was 50% or more of the track pitch.

The result of servo positioning evaluation shows that positioning was possible by 3σ<10% of track pitch in the obtained medium. The medium manufactured by this example had patterns trackable by servo tracking, and operated as a bit-patterned medium without any problem.

After the medium passed the servo positioning evaluation, the ratio of peeling of the protective layer was checked.

The peeling of the protective layer was evaluated by driving the medium incorporated into a drive for a few days, and observing the head and medium with a microscope. If peeling occurs, a deposit forms on the head, and the medium is damaged. The evaluation was performed by checking the ratio of drives like this. The evaluation was o when the ratio was less than one drive per 100 drives, Δ when the ratio was about 10 drive per 100 drives, and x when the ratio was 20 drives or more per 100 drives.

In addition, after the medium was left to stand in a high-temperature, high-humidity environment for a month, the change in coercive force Hc in the pattern area was checked by means of a Kerr effect measuring instrument. The evaluation was that the greater the change, the lower the environmental resistance.

Table 1 below collectively shows data of the C concentration with respect to the depth from the interface between the protective layer and non-recording portion, and data of peeling.

As shown in Table 1, the patterned medium according to the embodiment causes no peeling and is capable of high-quality recording and reproduction.

### Comparative Example 1

A patterned medium was manufactured following the same procedures as in Example 1 except that Mo and the C protective layer were removed by Ar milling, and P⁺ F was implanted with CoPt as the recording layer being exposed. Consequently, no protective layer component was contained and only CoPt and P distributed in the non-recording portion. After that, the Mo mask was lifted off in accordance with the steps from FIG. 7G, and a C protective layer was formed by CVD.

The patterned medium manufactured by the above method was incorporated into a drive, and servo positioning evaluation was performed. Consequently, a head crash occurred in a plurality of drives after 24-hour operation. When each medium was removed from the drive and inspected, peeling of the protective layer was observed in the non-recording portion. This is so presumably because the adhesion between the protective layer and non-recording portion worsened.

In the same manner as in Example 1, after the medium was left to stand in a high-temperature, high-humidity environment for a month, the change in coercive force Hc in the pattern area was checked.

Table 1 below shows the obtained results.

### Example 2

Patterned media of Examples 2-1 to 2-3 were manufactured following the same procedures as in Example 1 except that the ion implantation energy was changed in the step shown in FIG. 7F, thereby changing the C concentration in the film as shown in Table 1. After each medium was incorporated into a drive and it was confirmed that the medium passed servo positioning evaluation following the same procedures as in Example 1, the ratio of peeling of the protective layer was checked in the same manner as in Example 1.

In addition, after each medium was left to stand in a high-temperature, high-humidity environment for a month, the change in coercive force Hc in the pattern area was checked. Evaluation was that the larger the change, the lower the environmental resistance. Table 1 collectively shows data of the C concentration with respect to the depth from the interface between the protective layer and non-recording portion, and data of peeling.

TABLE 1

| | | | | Peeling | | | | |
|---|---|---|---|---|---|---|---|---|
| | Depth | | | of | | | | |
| | 1 | 5 | 9 | protective | | Change | | Overall |
| | (nm) | (nm) | (nm) | layer | Evaluation | in Hc | Evaluation | evaluation |
| Example 1 | 5% | 5% | 5% | 0% | ∘ | 5% | ∘ | ∘ |
| Comparative | 0% | 0% | 0% | 50% | x | 10% | □ | x |
| Example 1 | | | | | | | | |
| Example 2-1 | 30% | 8% | 4% | 0% | ∘ | 5% | ∘ | ∘ |
| Example 2-2 | 15% | 15% | 15% | 0% | ∘ | 8% | ∘ | ∘ |
| Example 2-3 | 1% | 10% | 30% | 10% | □ | 10% | □ | □ |

As shown in Table 1, in each medium in which the film of the non-recording portion contained the component of the protective layer, the adhesion of the protective layer improved, and no peeling occurred. This reveals that the patterned medium according to the embodiment is capable of high-quality recording and reproduction.

### Example 3

Patterned media of Examples 3-1 to 3-6 were manufactured following the same procedures as in Example 1 except that CNₓ or CH_{y} was used instead of C (DLC) as an actual protective layer, a gaseous mixture of CH₄ and N₂ was used as CNₓ, gaseous CH₄ was used as CH, and the values of x and y were changed by mass separation. After each medium was incorporated into a drive and it was confirmed that the medium passed servo positioning evaluation, the ratio of peeling of the protective layer was checked. The protective layer material was added to the non-recording portion by ion implantation. Table 2 collectively shows data of the C concentration with respect to the depth from the interface between the protective layer and non-recording portion, and data of peeling.

TABLE 2

| | Pro- | | | | | | |
|---|---|---|---|---|---|---|---|
| | tective | | Depth | | | Peeling of | |
| | film | | 1 | 5 | 9 | protective | Evalu- |
| | species | x or y | (nm) | (nm) | (nm) | layer | ation |
| Example 1 | C | — | 5% | 5% | 5% | 0% | ∘ |
| Comparative | C | — | 0% | 0% | 0% | 50% | x |
| Example 1 | | | | | | | |
| Example 3-1 | CNx | 1/10 | 5% | 5% | 5% | 0% | ∘ |
| Example 3-2 | CNx | 1/5 | 5% | 5% | 5% | 0% | ∘ |
| Example 3-3 | CNx | 1/3 | 5% | 5% | 5% | 1% | ∘ |
| Example 3-4 | CHy | 1/10 | 5% | 5% | 5% | 0% | ∘ |
| Example 3-5 | CHy | 1/3 | 5% | 5% | 5% | 0% | ∘ |
| Example 3-6 | CHy | 2/3 | 5% | 5% | 5% | 2% | ∘ |

As shown in Table 2, the patterned medium according to the embodiment causes almost no protective layer peeling and is capable of high-quality recording and reproduction.

Also, when the concentration distribution of the protective layer component was changed in the same manner as in Example 2, almost the same results as those of Example 2 were obtained although CNₓ or CH_{y} was used as the protective layer.

As described above, the same results as those of Example 1 were obtained even when the protective layer component was changed to CNₓ or CH_{y}.

### Example 4

Patterned media of Examples 4-1 to 4-5 were manufactured following the same procedures as in Example 2 except that the ion implantation energy was changed in the step shown in FIG. 7F, thereby changing the C concentration in the film. After each medium was incorporated into a drive together with the medium of Example 1 and the medium of the comparative example and it was confirmed that each medium passed servo positioning evaluation, the ratio of peeling of the protective layer was checked. In addition, after each medium was left to stand in a high-temperature, high-humidity environment for a month, the change in coercive force Hc in the pattern area was checked. Table 3 collectively shows data of the C concentration with respect to the depth from the interface between the protective layer and non-recording portion, and data of peeling.

TABLE 3

| | | | | Peeling | | | | |
|---|---|---|---|---|---|---|---|---|
| | Depth | | | of | | | | |
| | 1 | 5 | 9 | protective | | Change | | Overall |
| | (nm) | (nm) | (nm) | layer | Evaluation | in Hc | Evaluation | evaluation |
| Example 1 | 5% | 5% | 5% | 0% | ∘ | 5% | ∘ | ∘ |
| Comparative | 0% | 0% | 0% | 50% | x | 10% | □ | x |
| Example 1 | | | | | | | | |
| Example 4-1 | 1% | 1% | 1% | 0% | ∘ | 5% | ∘ | ∘ |
| Example 4-2 | 8% | 10% | 20% | 0% | ∘ | 7% | ∘ | ∘ |
| Example 4-3 | 15% | 20% | 20% | 0% | ∘ | 8% | □ | □ |
| Example 4-4 | 19% | 30% | 30% | 0% | ∘ | 10% | □ | □ |
| Example 4-5 | 21% | 40% | 40% | 0% | ∘ | 15% | □ | □ |

As shown in Table 3, in each medium in which the film of the non-recording portion contained the component of the protective layer, the adhesion of the protective layer improved, and no peeling occurred.

### Example 5

The effect of adding the element of the deactivating species to the recording layer was checked. Patterned media according to the embodiment were obtained following the same procedures as in Example 1 except that Co₈₀Pt₂₀ was used as the recording layer, As, Sb, and Bi ions were used as the element of the deactivating species instead of P⁺ ions, and the ratio of each element to Co was changed as shown in Table 4 below.

When the Ms of each obtained patterned medium was measured by the VSM, the Ms reduced in a region where the concentration with respect to Co was 1 at % or more, and became half or less in a region where the concentration with respect to Co was 3 at % or more. By contrast, when implanting B prepared as Comparative Example 2, a concentration at which the Ms reduced was comparatively high, and the Ms became half or less when the concentration was 30 at % or more.

The above results reveal that the deactivation effect of the deactivating species was obtained at a low concentration in the patterned medium according to the embodiment. The patterned medium manufactured using these elements had sufficient performance as a patterned medium because a sufficient difference was produced in signal intensity between the recording portion and non-recording portion.

Also, the same experiment was conducted on media obtained by changing the recording layer to various materials, and the results as shown in Table 4 below were obtained. For a medium in which the magnetic recording layer contained no magnetic element such as CrPt, the ratio of the deactivating species was the concentration with respect to the total of all the elements. As Comparative Example 3, a medium not containing the element of the deactivating species (only the component of the protective layer was added at the same concentration as that of the examples) was prepared.

TABLE 4

| | Recording layer | P concentration | Ms (%) | Evaluation |
|---|---|---|---|---|
| Example 5-1 | Co₈₀Pt₂₀ | 7% | 4% | ∘ |
| Example 5-2 | Fe₅₀Pt₅₀ | 10% | 3% | ∘ |
| Example 5-3 | Co₅₀Pt₅₀ | 5% | 4% | ∘ |
| Example 5-4 | Co/Pd | 5% | 4% | ∘ |
| | superlattice | | | |
| Example 5-5 | Cr₂₅Pt₇₅ | 10% | 5% | ∘ |
| Example 5-6 | Ni/Pd | 10% | 4% | ∘ |
| | superlattice | | | |
| Comparative | Co₈₀Pt₂₀ | 0% | 50% | □ |
| Example 2 | | (B30%) | | |
| Comparative | Co₈₀Pt₂₀ | 0% | 100% | x |
| Example 3 | | | | |

These tendencies similarly apply to deactivating species (As, Sb, and Bi) other than P.

As described above, even when the material of the recording layer was changed, magnetism deactivation occurred in the configuration proposed by this patent, and magnetic patterning was possible.

### Example 6

Magnetic recording media were manufactured following the same procedures as in Example 1 except that the deactivating species was changed and the change in volume of the recording layer was checked. After that, a protective layer was stacked, and the adhesion was checked. Table 5 below collectively shows the results.

The volume increase ratio was measured by measuring cross-sectional TEM, and measuring the film thickness difference between the recording area and non-recording area. Evaluation was a double circle when the volume increase ratio was less than 5%, and o when the volume increase ratio was 10% or less.

TABLE 5

| | | | Implantation | Volume | | Peeling of | | |
|---|---|---|---|---|---|---|---|---|
| | Recording | Implanted | concentration | increase | | protective | | Oveall |
| | layer | element | (%) | ratio | Evaluation | layer | Evaluation | evaluation |
| Example 1 | CoPt | P | 7% | 5% | ∘ | 5% | ∘ | ∘ |
| Comparative | Copt | None | 0% | 0% | □ | 50% | x | x |
| Example 1 | | | | | | | | |
| Example 6-1 | CoPt | As | 7% | 7% | ∘ | 5% | ∘ | ∘ |
| Example 6-2 | CoPt | Sb | 7% | 9% | ∘ | 4% | ∘ | ∘ |
| Example 6-3 | CoPt | Bi | 7% | 10% | ∘ | 2% | ∘ | ∘ |

When the deactivating species was changed as described above, the volume increase ratio increased as the atomic number increased. However, no problem arose when the volume increase ratio was 10% or less. The same tendency was found when using other recording layers.

This demonstrates that the patterned medium according to the embodiment causes almost no protective layer peeling and is capable of high-quality recording and reproduction.

### Example 7

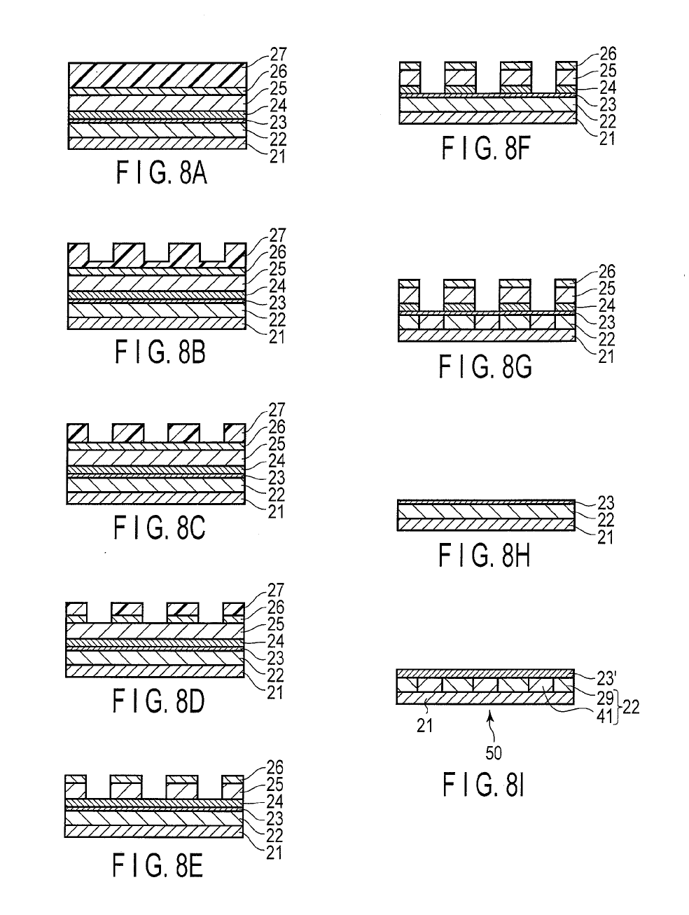

FIGS. 8A, 8B, 8C, 8D, 8E, 8F, 8G, 8H, and 8I are exemplary views for explaining another example of the method of manufacturing the magnetic recording medium according to the embodiment.

These exemplary views shown in FIGS. 8A, 8B, 8C, 8D, 8E, 8F, 8G, 8H, and 8I are the same as the exemplary views shown in FIGS. 7A, 7B, 7C, 7D, 7E, 7F, 7G, and 7H except that steps shown in FIGS. 8F and 8G are used instead of the step shown in FIG. 7F.

In FIGS. 8A, 8B, 8C, 8D, and 8E of this method, patterns are transferred by etching the second hard mask 25 made of C by using the patterned third hard mask 26 as a mask, thereby exposing the surface of the first hard mask 24 in the recesses, in the same manner as in FIGS. 7A, 7B, 7C, 7D, and 7E. For example, this step is performed for an etching time of 30 s with an inductively coupled plasma (ICP) RIE apparatus using O₂ as a process gas at a chamber pressure of 0.1 Pa, a coil RF power of 100 W, and a platen RF power of 50 W.

Then, as shown in FIG. 8F, the patterns are transferred onto the first hard mask 24 by ion beam etching by using the patterned second hard mask 25 as a mask, thereby exposing the DLC protective layer 23 in the recesses. For example, this step is performed for an etching time of 10 s with the inductively coupled plasma (ICP) RIE apparatus using CF₄ as a process gas at a chamber pressure of 0.1 Pa, a coil RF power of 100 W, and a platen RF power of 30 W.

As shown in FIG. 8G, the magnetism of a non-recording portion is deactivated through the DLC protective layer 52. For example, this step is performed for a processing time of 60 s by sequentially emitting P⁺ ions and C⁺ ions at acceleration energies of 7 and 5 keV, respectively, by ion implantation at a dose of ˜10¹⁶ atoms/cm².

As shown in FIG. 8H, the remaining first hard mask (Mo) 24 is removed together with its upper layers, in the same manner as in FIG. 7G. In this step, the medium is dipped in, for example, a hydrogen peroxide solution having a concentration of 0.1% and held for 30 min, thereby removing the remaining second hard mask 25 and all the films deposited on it.

As shown in FIG. 8I, a protective layer 23′ is formed by depositing DLC by chemical vapor deposition (CVD), and coated with a lubricant (not shown), thereby obtaining a patterned medium 50 according to the embodiment in which a magnetic recording layer 22 including a recording portion 29 and non-recording portion 41, the protective layer 23′, and the lubricating layer are formed on the substrate 21.

The manufactured patterned medium was incorporated into a drive, and servo positioning evaluation was performed. As a consequence, positioning was possible when 3σ was 10% or less of the track pitch. That is, the medium manufactured by this example operated as a bit-patterned medium without any problem.

### Example 8

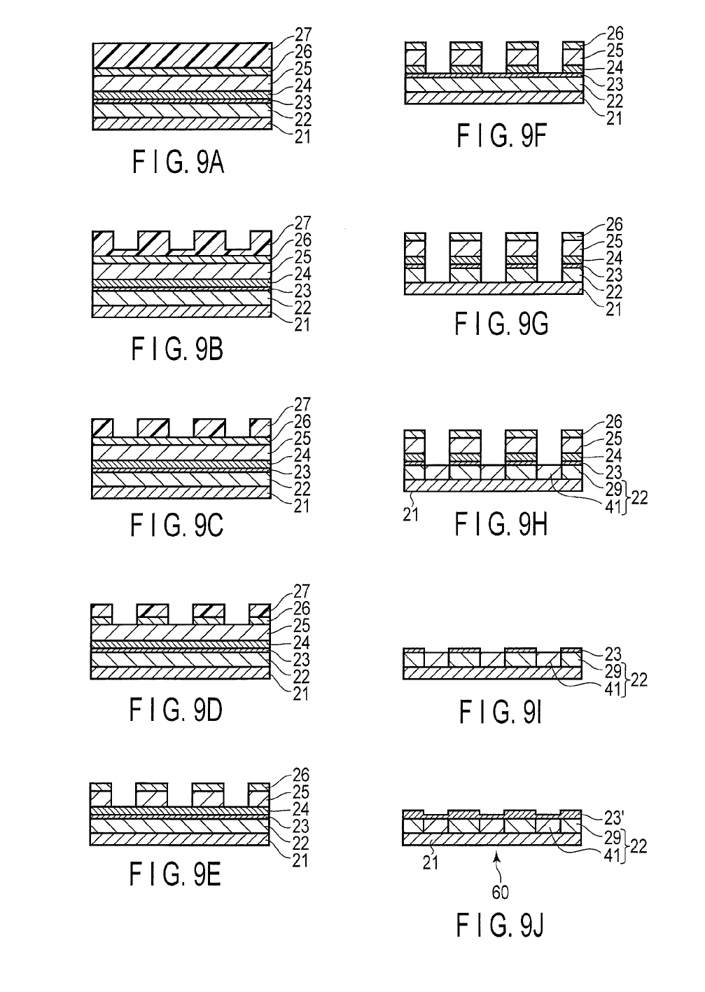

FIGS. 9A, 9B, 9C, 9D, 9E, 9F, 9G, 9H, 9I, and 9J are exemplary views for explaining still another example of the method of manufacturing the magnetic recording medium according to the embodiment.

In these exemplary views shown in FIGS. 9A, 9B, 9C, 9D, 9E, 9F, 9G, 9H, 9I, and 9J, steps shown in FIGS. 9A, 9B, 9C, 9D, and 9E are the same as the steps shown in FIGS. 7A, 7B, 7C, 7D, and 7E, and steps shown in FIGS. 9F, 9G, 9H, 9I, and 9J are used instead of the steps shown in FIGS. 7F, 7G, and 7H.

In FIGS. 9A, 9B, 9C, 9D, and 9E of this method, patterns are transferred by etching the second hard mask 25 made of C by using the patterned third hard mask 26 as a mask, thereby exposing the surface of the first hard mask 24 in the recesses, in the same manner as in FIGS. 7A, 7B, 7C, 7D, and 7E. For example, this step is performed for an etching time of 30 s with an inductively coupled plasma (ICP) RIE apparatus using O₂ as a process gas at a chamber pressure of 0.1 Pa, a coil RF power of 100 W, and a platen RF power of 50 W.

Then, as shown in FIG. 9F, the patterns are transferred onto the first hard mask 24 by ion beam etching by using the patterned second hard mask 25 as a mask, thereby exposing the DLC protective layer 23 in the recesses. For example, this step is performed for an etching time of 10 s with the inductively coupled plasma (ICP) RIE apparatus using CF₄ as a process gas at a chamber pressure of 0.1 Pa, a coil RF power of 100 W, and a platen RF power of 30 W.

As shown in FIG. 9G, all exposed portions of the DLC protective layer 23 and magnetic recording layer 22 are etched by ion beam etching by using the patterned first and second hard masks as masks. For example, this step is performed for etching time of 30 s with an Ar ion milling apparatus using Ar as a process gas at a chamber pressure of 0.04 Pa and a beam acceleration voltage of 400 eV.

As shown in FIG. 9H, trenches are filled. A material to be filled contains Co₈₀Pt₂₀ as a main component from the viewpoint of environmental stability, and also contains 5% of CH_{0.5} as a protective layer stabilizing layer and 10% of P as a magnetism deactivating species. This step is performed for a deposition time of 10 s with, for example, a facing-target-type deposition apparatus using gaseous Ar at a chamber pressure of 0.07 Pa.

As shown in FIG. 9I, the remaining first hard mask (Mo) 24 is removed together with its upper layers. In this step, the medium is dipped in, for example, a hydrogen peroxide solution having a concentration of 0.1% and held for 30 min, thereby removing the remaining second hard mask 25 and all the films deposited on it.

As shown in FIG. 9J, a protective layer 23′ is formed by depositing DLC by chemical vapor deposition (CVD), and coated with a lubricant, thereby obtaining a patterned medium 60 according to the embodiment in which a magnetic recording layer 22 including a recording portion 29 and non-recording portion 41, the protective layer 23′, and the lubricating layer are formed on the substrate 21.

The manufactured patterned medium was incorporated into a drive, and servo positioning evaluation was performed. Consequently, positioning was possible when 3σ was 10% or less of the track pitch. That is, the medium manufactured by this example operated as a bit-patterned medium without any problem.

The adhesion to the protective layer can be increased not only by mixing the element of the magnetism deactivating species in the non-recording portion, but also by adding the element having the same composition as that of the protective layer. In addition, since the element having the same composition as that of the protective layer is added, the effect as the protective layer does not deteriorate even when the thickness of the protective layer in the non-recording portion decreases.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording medium comprising:
a substrate;
a magnetic recording layer on the substrate, the magnetic recording layer comprising
a recording portion comprising a magnetic material and patterns arranged in a longitudinal direction, and
a non-recording portion comprising the magnetic material and a deactivating species with a value of saturation magnetization smaller than a saturation magnetization in the recording portion; and
a protective layer on the magnetic recording layer,
wherein the non-recording portion further comprises a component of the protective layer.

2. The medium of claim 1, wherein a composition ratio of the protective layer component in the magnetic recording layer changes in a thickness direction, and a composition ratio of the protective layer component on a protective layer side is higher than that of the protective layer component on a substrate side.

3. The medium of claim 1, wherein the component of the protective layer is selected from the group comprising C, CN, and CH.

4. The medium of claim 1, wherein the deactivating species comprises at least one element from the group comprising P, As, Sb, and Bi.

5. The medium of claim 1, wherein the protective layer is in contact with the magnetic recording layer, and a distance h2 from the substrate to an interface between the non-recording portion and the protective layer is greater than a distance h1 from the substrate to an interface between the recording portion and the protective layer.

6. The medium of claim 1, further comprising an orientation control interlayer between the substrate and the magnetic recording layer,
wherein the non-recording portion further comprises a component of the orientation control interlayer, and a composition ratio of the orientation control interlayer component in the non-recording portion is higher than that of the orientation control interlayer component in the recording portion.

7. The medium of claim 6, wherein the component of the orientation control interlayer comprises ruthenium.

8. A magnetic recording medium manufacturing method comprising:
forming a mask layer comprising projections comprising arranged patterns on a surface of a protective layer of a magnetic recording medium comprising a substrate, a magnetic recording layer on the substrate, and the protective layer on the magnetic recording layer; and
performing, through the mask layer, ion beam irradiation of a magnetic material and a deactivating species making a value of saturation magnetization smaller than a saturation magnetization in a recording portion, thereby forming, in the magnetic recording layer:
the recording portion comprising arranged patterns, and
a non-recording portion comprising the deactivating species and a component of the protective layer and comprising a saturation magnetization lower than in the recording portion.

9. The method of claim 8, wherein the deactivating species comprises at least one element from the group comprising P, As, Sb, and Bi.

10. The method of claim 8, further comprising performing ion beam irradiation of the protective layer component in addition to the deactivating species.

11. The method of claim 8, wherein the component of the protective layer is selected from the group comprising C, CN, and CH.
